(19) United States
(12) Patent Application Publication
(10) Pub. No.: US 2024/0221394 A1
(43) Pub. Date: Jul. 4, 2024

(54) POSITIONING SYSTEM, POSITIONING METHOD AND VEHICLE

(71) Applicant: KABUSHIKI KAISHA TOSHIBA, Tokyo (JP)

(72) Inventor: Jumpei OGAWA, Kawasaki Kanagawa (JP)

(73) Assignee: KABUSHIKI KAISHA TOSHIBA, Tokyo (JP)

(21) Appl. No.: 18/451,459

(22) Filed: Aug. 17, 2023

(30) Foreign Application Priority Data
Jan. 4, 2023 (JP) 2023-000138

(51) Int. Cl. G06V 20/56; B60W 40/06

(52) U.S. Cl. CPC G06V 20/588; B60W 40/06; B60W 2420/42

(57) ABSTRACT

According to one embodiment, a positioning system includes a sensor section and a processor. The sensor section is provided in a vehicle. The sensor section includes a first image sensor configured to image a road surface. The vehicle is configured to travel in the roar surface. The processor is configured to process a first information including a first image information regarding the road surface obtained by the first image sensor. The processor is configured to derive a direction information regarding a direction of the vehicle based on the first information.

### CROSS-REFERENCE TO RELATED APPLICATIONS

This application is based upon and claims the benefit of priority from Japanese Patent Application No. 2023-000138, filed on Jan. 4, 2023; the entire contents of which are incorporated herein by reference.

### FIELD

Embodiments described herein relate generally to a positioning system, a positioning method and a vehicle.

### BACKGROUND

For example, there is a positioning system that detects the position of a vehicle. Improved performance is desired in positioning systems.

### BRIEF DESCRIPTION OF THE DRAWINGS

FIG. 1 is a schematic diagram illustrating a positioning system according to a first embodiment;

FIG. 2 is a schematic diagram illustrating an operation of the positioning system according to the first embodiment;

FIG. 3 is a schematic plan view illustrating the operation of the positioning system according to the first embodiment;

FIG. 4 is a schematic plan view illustrating the operation of the positioning system according to the first embodiment;

FIG. 5 is a schematic plan view illustrating the operation of the positioning system according to the first embodiment; and

FIG. 6 is a schematic plan view illustrating the operation of the positioning system according to the first embodiment.

### DETAILED DESCRIPTION

According to one embodiment, a positioning system includes a sensor section and a processor. The sensor section is provided in a vehicle. The sensor section includes a first image sensor configured to image a road surface. The vehicle is configured to travel in the roar surface. The processor is configured to process a first information including a first image information regarding the road surface obtained by the first image sensor. The processor is configured to derive a direction information regarding a direction of the vehicle based on the first information.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

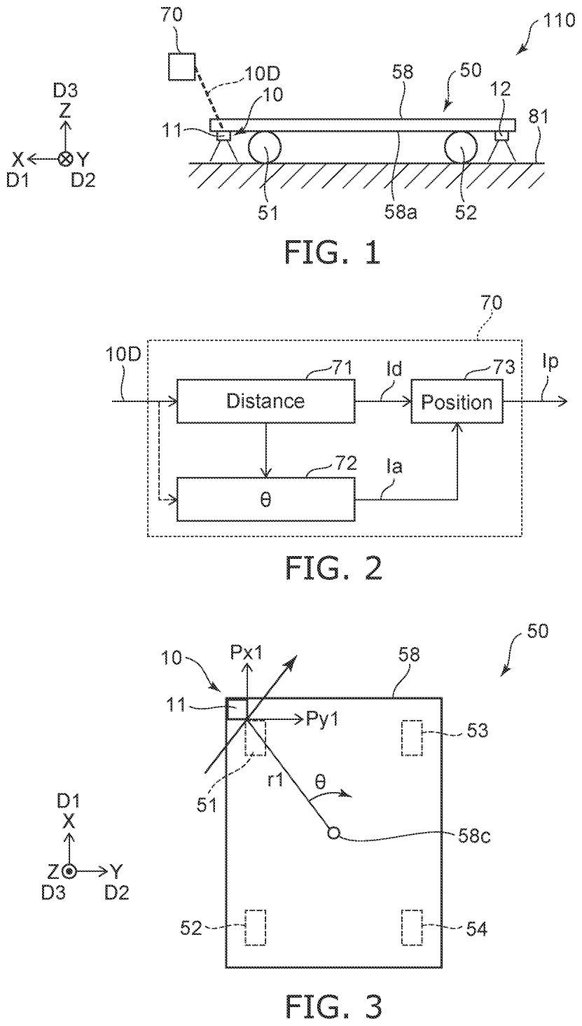

FIG. 1 is a schematic diagram illustrating a positioning system according to a first embodiment.

As shown in FIG. 1, a positioning system 110 according to the embodiment includes a sensor section 10 and a processor 70.

The sensor section 10 is provided in a vehicle 50. The sensor section 10 includes a first image sensor 11. The first image sensor 11 is configured to capture an image of a road surface 81 on which the vehicle 50 travels. As shown in FIG. 1, the sensor section 10 may include a second image sensor 12 and the like.

In one example, the vehicle 50 may include a base section 58. The base section 58 is apart from the road surface 81. A moving mechanism (for example, a first moving part 51 and the second moving part 52, etc.) is provided on the base section 58. The moving mechanism may be, for example, wheels.

The base section 58 includes a base face 58a. The base face 58a faces the road surface 81. The first image sensor 11 and the second image sensor 12 are provided, for example, on the base face 58a. In the embodiment, various modifications are possible for the place where the image sensor is provided.

The processor 70 is configured to obtain a first information 10D. The processor 70 may be provided in the vehicle 50. The processor 70 may be provided at a location away from the vehicle 50. Information transfer (for example, communication) between the processor 70 and the sensor section 10 may be performed by any method such as wireless or wired.

The first information 10D includes, for example, a first image information regarding the road surface 81 obtained by the first image sensor 11. In the embodiment, the processor 70 is configured to derive a direction information regarding a direction of the vehicle 50 based on the first information 10D. Thereby, a positioning system capable of improving performance can be provided.

For example, a reference example in which a vehicle is provided with an inertial sensor and an image sensor can be considered. In this reference example, the direction of the vehicle is estimated by the inertial sensor (for example, an angular velocity sensor). Then, the movement distance (movement amount) of the vehicle is estimated from the result of the road surface imaged by the image sensor. In the reference example, the position of the vehicle is estimated from the moving distance and direction. In this reference example, an error occurs due to, for example, noise in the inertial sensor.

In contrast, in the embodiment, the direction of the vehicle 50 is estimated based on information from the image sensor. As a result, errors due to noise in the inertial sensor do not occur, so the direction can be estimated with high accuracy. In the embodiment, the first information 10D obtained from the sensor section 10 does not include information from the inertial sensor. Since the inertial sensor can be omitted, the cost can be reduced. For example, the position information of the vehicle 50 traveling indoors can be accurately estimated without using a GPS (Global Positioning System) or the like.

As shown in FIG. 1, a direction from the road surface 81 to the vehicle 50 is defined as a Z-axis direction. One direction perpendicular to the Z-axis direction is defined as an X-axis direction. A direction perpendicular to the Z-axis direction and the X-axis direction is defined as a Y-axis direction. The vehicle 50 moves substantially in the X-Y plane. One direction regarding the movement is defined as a first direction D1. Another direction regarding the movement is defined as a second direction D2. The second direction D2 crosses the first direction D1. The second direction D2 is, for example, orthogonal to the first direction D1. The first direction D1 may correspond to, for example, the X-axis direction. The second direction D2 may correspond to, for example, the Y-axis direction. A third direction D3 crosses a plane including the first direction D1 and the second direction D2. The third direction D3 is, for example, the Z-axis direction.

FIG. 2 is a schematic diagram illustrating an operation of the positioning system according to the first embodiment.

FIG. 2 illustrates the operation of the processor 70. The processor 70 is provided with the first information 10D. As shown in FIG. 2, the processor 70 may be configured to execute a first process 71, a second process 72, and a third process 73, for example.

In the first process 71, the processor 70 is configured to derive a movement amount information Id regarding the movement amount of the vehicle 50 based on the first information 10D. For example, with respect to the image information of the road surface 81 acquired by the first image sensor 11 at different times, the amount of movement on the X-Y plane is obtained from the gradation change of pixels. The Lucas-Kanade method is a typical method of estimating the amount of movement. In this method, the amount of movement is determined by paying attention to a pixel at a certain point and pixels near the pixel. By this method, a solution can be uniquely obtained by calculation. Generally, the road surface 81 has a shadow based on a scratch, an unevenness or the like. Image information including shading changes according to the movement of the vehicle 50. The amount of movement of the vehicle 50 can be estimated by processing the image information.

In the second processing 72, the processor 70 is configured to derive a direction information Ia regarding the direction (angle θ) of the vehicle 50 based on the first information 10D. In this example, the processor 70 derives the direction information Ia based on the distance between the position of the first image 10 sensor 11 in the vehicle 50 and the rotation center of the vehicle 50 and at least a part of the movement amount. An example of the derivation of the direction information Ia will be described later.

In the third process 73, the processor 70 is configured to derive a position information Ip regarding the position of the vehicle 50 based on the direction information Ia and the movement amount information Id. For example, the position information (Ipx, Ipy) in the X-axis direction and the Y-axis direction on the positioning coordinates can be calculated by the 20 following first equation using the direction information Ia and the movement amount information Id.

$$Ipx ( i ) = Ipx ( i - 1 ) + Id ( i ) * sin ( Ia ( i ) ) \qquad ( 1 )$$

$$Ipy ( i ) = Ipy ( i - 1 ) + Id ( i ) * cos ( Ia ( i ) )$$

“i” represents a processing step. The movement amount on the positioning coordinate calculated from the direction information Ia and the movement amount information Id is added to the position information of the preceding processing step. Thus, the position (position information Ip) of the vehicle 50 can be estimated.

An example of deriving the direction information Ia will be described below.

FIG. 3 is a schematic plan view illustrating the operation of the positioning system according to the first embodiment.

As shown in FIG. 3, in this example, the vehicle 50 includes four moving mechanisms (For example, the first moving part 51, the second moving part 52, the third moving part 53, and the fourth moving part 54). These moving parts are, for example, wheels. The vehicle 50 has a rotation center 58c. The rotation center 58c is, for example, the center of four moving mechanisms.

The distance between the position of the first image sensor 11 in the vehicle 50 and the rotation center 58c of the vehicle 50 is defined as a first distance r1. The first image sensor 11 may be provided at the end of the base section 58 of the vehicle 50.

As described above, the processor 70 is configured to derive the movement amount information Id regarding the movement amount of the vehicle 50 based on the first image information (first information 10D) regarding the road surface 81 obtained from the first image sensor 11. The movement amount includes a first direction movement amount Px1 in the first direction D1 and a second direction movement amount Py1 in the second direction D2. A plane including the first direction D1 and the second direction D2 crosses a third direction D3 (Z axis direction) from the road surface 81 to the first image sensor 11. The second direction D2 is orthogonal to the first direction D1. The first direction movement amount Px1 is, for example, a component of the movement amount in the X-axis direction. The second direction movement amount Py1 is, for example, a component of the movement amount in the Y-axis direction.

The direction information Ia includes information regarding the first angle θ1. The first angle θ1 (degrees) is expressed as follows:

$$[ \{ {( Px {1}^{2} + Py {1}^{2} )}^{1 / 2} \} / ( 2 π \times r 1 ) ] \times 360. \qquad ( 2 )$$

The rotation direction can be determined from the positive and negative sign information of the first direction movement amount Px1 and the second direction movement amount Py1.

The processor 70 is configured to derive the direction (first angle θ1) based on the first direction movement amount Px1, the second direction movement amount Py1, and the first distance r1 by using the above second equation. The first distance r1 may be stored in a memory. The memory may be included in the processor 70. The memory may be provided separately from the processor 70.

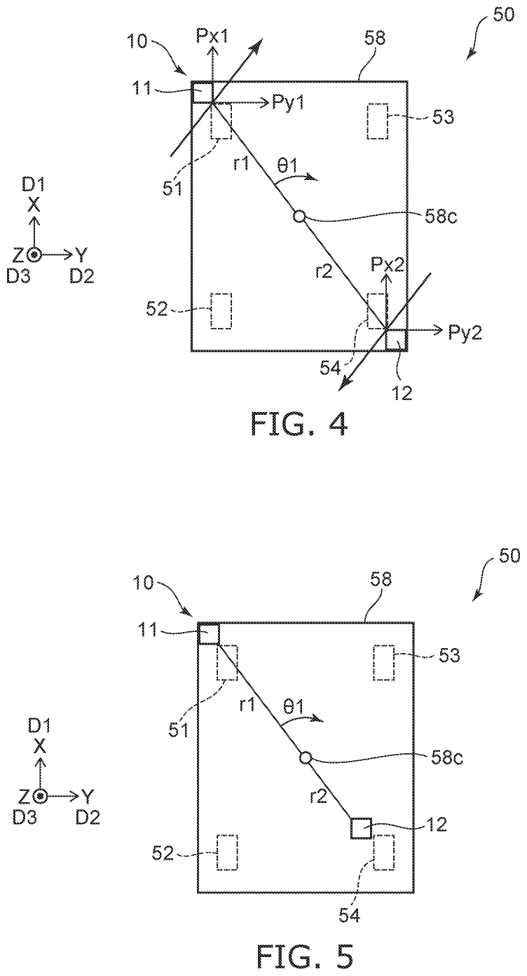

FIG. 4 is a schematic plan view illustrating the operation of the positioning system according to the first embodiment.

As shown in FIG. 4, the sensor section 10 may include a second image sensor 12 in addition to the first image sensor 11 (see FIG. 1). As shown in FIG. 1, the second image sensor 12 is configured to image the road surface 81. The first information 10D includes a second image information regarding the road surface 81 obtained by the second image sensor 12.

The processor 70 may derive the direction of the vehicle 50 based on the first image information from the first image sensor 11 and the second image information from the second image sensor 12.

As described above, the moving direction of the vehicle 50 includes a first component along the first direction D1 and a second component along the second direction D2. The plane including the first direction D1 and the second direction D2 crosses the third direction D3 from the road surface 81 to the first image sensor 11. The second direction D2 is orthogonal to the first direction D1.

As shown in FIG. 4, the position where the second image sensor 12 is provided is different from the position where the first image sensor 11 is provided. For example, the position of the rotation center 58c of the vehicle 50 in the first direction D1 is between the position of the first image sensor 11 in the first direction D1 and the position of the second image sensor 12 in the first direction D1. The position of the rotation center 58c in the second direction D2 is between the position of the first image sensor 11 in the second direction D2 and the position of the second image sensor 12 in the second direction D2.

For example, in a plane (e.g., X-Y plane) perpendicular to the direction from the road surface 81 to the first image sensor 11 (third direction D3), the rotation center 58c of the vehicle 50 may be between at least a part of the first image sensor 11 and at least a part of the second image sensor 12.

The direction is estimated based on the second image information obtained from the second image sensor 12 and the first image information obtained from the first image sensor. Thereby, the direction can be estimated with higher accuracy.

The calculation of the direction using the second image information may be performed in the same manner as the calculation of the direction using the first image information.

For example, as shown in FIG. 4, a distance between the position of the second image sensor 12 in the vehicle 50 and the rotational center 58c of the vehicle 50 is defined as a second distance r2. In the second image information, the movement amount of the vehicle 50 includes a third direction movement amount Px2 in the first direction D1 and a fourth direction movement amount Px2 in the second direction D2. The second angle θ2 (degree) derived from the second image information is expressed by following formula 3:

$$[ \{ {( Px {2}^{2} + Py {2}^{2} )}^{1 / 2} \} / ( 2 π \times r 2 ) ] \times 360. \qquad ( 3 )$$

The rotation direction may be determined from positive and negative sign information such as the first direction movement amount Px1, the second direction movement amount Py1, the third direction movement amount Px2, and the fourth direction movement amount Py2.

A case where the direction (the first angle θ1) estimated from the first image information is the same as the direction estimated from the second image information (the second angle θ2) corresponds to a rotation. A case where the direction (first angle θ1) estimated from the first image information is opposite to the direction (second angle θ2) estimated from the second image information corresponds to a translation. Thus, the processor 70 can distinguish the rotation of the vehicle 50 from the translation of the vehicle 50.

In this embodiment, for example, the position of the rotation center 58c of the vehicle 50 in the first direction D1 is between the position of the first image sensor 11 in the first direction D1 and the position of the second image sensor 12 in the first direction D1. In this case, the position of the rotation center 58c in the second direction D2 may not be between the position of the first image sensor 11 in the second direction D2 and the position of the second image sensor 12 in the second direction D2.

For example, the position of the rotation center 58c in the second direction D2 is between the position of the first image sensor 11 in the second direction D2 and the position of the second image sensor 12 in the second direction D2. In this case, the position of the rotation center 58c of the vehicle 50 in the first direction D1 may not be between the position of the first image sensor 11 in the first direction D1 and the position of the second image sensor 12 in the first direction D1. The location where the plurality of image sensors are provided can be varied.

FIG. 5 is a schematic plan view illustrating the operation of the positioning system according to the first embodiment.

As shown in FIG. 5, in this example, the first distance r1 between the rotation center 58c and the first image sensor 11 is different from the second distance r2 between the rotation center 58c and the second image sensor 12. Thereby, it becomes easy to avoid restrictions on the sensor installation position in the vehicle 50.

In the embodiment, the first distance r1 between the rotation center 58c and the first image sensor 11 may be longer than the distance between the rotation center 58c and the moving mechanism (e.g., the first moving portion 51). By the first distance r1 being long, the first angle θ1 can be estimated with high accuracy.

In the embodiment, the rotation center 58c may be calibrated by providing a plurality of image sensors and by moving of the vehicle 50 including rotation.

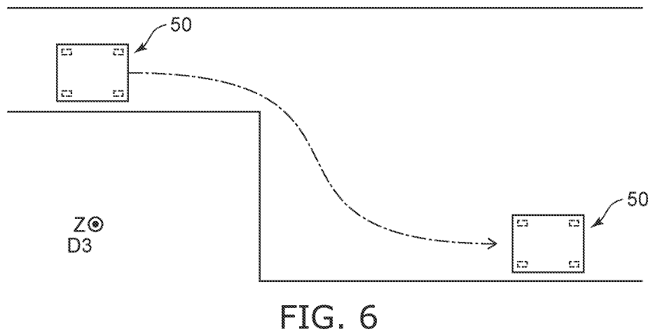

FIG. 6 is a schematic plan view illustrating the operation of the positioning system according to the first embodiment.

As shown in FIG. 6, the positioning system 110 according to the embodiment may estimate the position of the vehicle 50 based on the direction information Ia and the movement amount information Id. For example, the processor 70 is configured to estimate the moving direction. The processor 70 is configured to estimate the position.

### Second Embodiment

The second embodiment relates to a positioning method. In the positioning method, the direction information Ia regarding the direction of the vehicle 50 is derived based on the first information 10D including a first image information regarding the road surface 81 on which the vehicle 50 travels. The first image information is obtained by the first image sensor 11 included in the sensor section 10 provided in the vehicle 50.

The positioning method according to the embodiment may further derive the movement amount information Id regarding the movement amount of the vehicle 50 based on the first information 10D. In the positioning method, the position information Ip regarding the position of the vehicle 50 may be further derived based on the direction information Ia and the movement amount information Id.

For example, based on the first information 10D, the movement amount information Id regarding the movement amount of the vehicle 50 is derived. The direction information Ia may be derived based on the first distance r1 between the position of the first image sensor 11 in the vehicle 50 and the rotation center 58c of the vehicle 50 and at least a part of the amount of movement.

In the positioning method according to the embodiment, the sensor section 10 may further include the second image sensor 12. The second image sensor 12 is configured to image the road surface 81. The first information 10D may include the second image information regarding the road surface 81 obtained by the second image sensor 12. According to the embodiment, a positioning method capable of improving performance can be provided.

### Third Embodiment

The third embodiment relates to the vehicle 50. For example, as shown in FIGS. 1 and 4, the vehicle 50 includes the base section 58 and the sensor section 10. The sensor section 10 includes the first image sensor 11 and the second image sensor 12. The base section 58 is apart from the road surface 81 on which the vehicle 50 travels. The base section 58 includes the base face 58a facing the road surface 81. The first image sensor 11 and the second image sensor 12 are provided on the base face 58a.

The moving direction of the vehicle 50 includes the first component along the first direction D1 and the second component along the second direction D2. The plane including the first direction D1 and the second direction D2 crosses the third direction D3 from the road surface 81 to the first image sensor 11. The second direction D2 is orthogonal to the first direction D1.

The position of the rotation center 58c of the vehicle 50 in the first direction D1 is between the position of the first image sensor 11 in the first direction D1 and the position of the second image sensor 12 in the first direction D1.

In the vehicle 50 according to the embodiment, the position of the rotation center 58c in the second direction D2 may be between the position of the first image sensor 11 in the second direction D2 and the position of the second image sensor 12 in the second direction D2.

In the vehicle 50 according to the embodiment, the first distance r1 between the rotation center 58c and the first image sensor 11 may be different from the second distance r2 between the rotation center 58c and the second image sensor 12.

The vehicle 50 according to the embodiment may further include the processor 70. The processor 70 is configured to process the first information 10D including the first image information regarding the road surface 81 obtained by the first image sensor 11 and the second image information regarding the road surface 81 obtained by the second image sensor 12, and is configured to derive the direction information Ia regarding the direction of the vehicle 50 based on the first information 10D.

According to the embodiment, it is possible to provide a vehicle to which a positioning system capable of improving performance can be applied.

The embodiments may include the following configurations (for example, technical proposals).

### Configuration 1

A positioning system, comprising:
a sensor section provided in a vehicle, the sensor section including a first image sensor configured to image a road surface, the vehicle being configured to travel in the roar surface; and
a processor configured to process a first information including a first image information regarding the road surface obtained by the first image sensor, the processor being configured to derive a direction information regarding a direction of the vehicle based on the first information.

### Configuration 2

The positioning system according to Configuration 1, wherein
the processor is configured to derive a movement amount information regarding the movement amount of the vehicle based on the first information.

### Configuration 3

The positioning system according to Configuration 2, wherein
the processor is configured to derive a position information regarding the position of the vehicle based on the direction information and the movement amount information.

### Configuration 4

The positioning system according to Configuration 1, wherein
the processor is configured to derive a movement amount information regarding the movement amount of the vehicle based on the first information, and
the processor is configured to derive the direction information based on a first distance between a position of the first image sensor in the vehicle and a rotation center of the vehicle and at least a part of the moving amount.

### Configuration 5

The positioning system according to Configuration 1, wherein
the processor is configured to derive a movement amount information regarding the movement amount of the vehicle based on the first information,
the moving amount includes a first moving amount in a first direction and a second moving amount in a second direction,
a plane including the first direction and the second direction crosses a third direction from the road surface to the first image sensor,
the second direction is orthogonal to the first direction,
the direction information includes information regarding a first angle, and
the first angle (degree) is expressed by [{(Px1²+Py1²) 1/2}/(2π×r1)]×360,
the Px1 is the first direction moving amount,
the Py1 is the second direction moving amount, and
the r1 is a first distance between the position of the first image sensor in the vehicle and a rotation center of the vehicle.

### Configuration 6

The positioning system according to any one of Configurations 1-5, wherein
the vehicle includes a base section away from the road surface,
the base section includes a base face facing the road surface, and
the first image sensor is provided on the base face.

### Configuration 7

The positioning system according to any one of Configurations 1-3, wherein
the sensor section further includes a second image sensor,
the second image sensor is configured to image the road surface, and
the first information includes second image information regarding the road surface obtained by the second image sensor.

### Configuration 8

The positioning system according to Configuration 7, wherein
the processor is configured to distinguish a rotation of the vehicle and a translation of the vehicle based on the first image information and the second image information.

### Configuration 9

The positioning system according to Configuration 7, wherein
the moving direction of the vehicle includes a first component along a first direction and a second component along a second direction,
a plane including the first direction and the second direction crosses a third direction from the road surface to the first image sensor,
the second direction is orthogonal to the first direction,
a position of a rotation center of the vehicle in the first direction is between a position of the first image sensor in the first direction and a position of the second image sensor in the first direction, and
a position of the rotation center in the second direction is between a position of the first image sensor in the second direction and a position of the second image sensor in the second direction.

### Configuration 10

The positioning system according to Configuration 7, wherein
in a plane perpendicular to a direction from the road surface to the first image sensor, a rotation center of the vehicle is between at least a part of the first image sensor and at least a part of the second image sensor.

### Configuration 11

The positioning system according to Configuration 10, wherein
a first distance between the rotation center and the first image sensor is different from a second distance between the rotation center and the second image sensor.

### Configuration 12

The positioning system according to Configuration 1, wherein,
the first information does not include information from an inertial sensor.

### Configuration 13

A positioning method, comprising:
deriving a direction information regarding a direction of a vehicle based on a first information including a first image information regarding a road surface on which the vehicle travels,
the first image information being obtained by a first image sensor included in a sensor section provided in the vehicle.

### Configuration 14

The positioning method according to Configuration 13, further comprising:
deriving a moving amount information regarding a moving amount of the vehicle based on the first information.

### Configuration 15

The positioning method according to Configuration 14, further comprising:
deriving a position information regarding a position of the vehicle based on the direction information and the movement amount information.

### Configuration 16

The positioning method according to Configuration 13, further comprising:
deriving a movement amount information regarding the movement amount of the vehicle; and
deriving the direction information based on at least a part of the moving amount and a first distance between a position of the first image sensor in the vehicle and a rotation center of the vehicle.

### Configuration 17

The positioning method according to any one of Configurations 13-16, wherein
the sensor section further includes a second image sensor,
the second image sensor is configured to image the road surface, and
the first information includes second image information regarding the road surface obtained by the second image sensor.

### Configuration 18

A vehicle, comprising:
a base section; and
a sensor section including a first image sensor and a second image sensor,
the base section being away from a road surface, the vehicle being configured to travel on the road surface,
a moving direction of the vehicle including a first component along a first direction and a second component along a second direction,
a plane including the first direction and the second direction crossing a third direction from the road surface to the first image sensor,
the second direction being orthogonal to the first direction, and
a position of the rotation center of the vehicle in the first direction being between a position of the first image sensor in the first direction and a position of the second image sensor in the first direction.

### Configuration 19

The vehicle according to Configuration 18, wherein
a position of the rotation center in the second direction is between a position of the first image sensor in the second direction and a position of the second image sensor in the second direction.

### Configuration 20

The vehicle according to Configuration 18 or 19, further comprising:
a processor,
the processor being configured to process a first information including a first image information regarding the road surface obtained by the first image sensor and a second image information regarding the road surface obtained by the second image sensor, and to derive a direction information regarding a direction of the vehicle based on the first information.

According to the embodiment, a positioning system, a positioning method and a vehicle capable of improving performance can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in positioning systems such as, sensor sections, image sensors, processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all positioning systems, positioning methods and vehicles practicable by an appropriate design modification by one skilled in the art based on the positioning systems, positioning methods and vehicles described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A positioning system, comprising:
a sensor section provided in a vehicle, the sensor section including a first image sensor configured to image a road surface, the vehicle being configured to travel in the roar surface; and
a processor configured to process a first information including a first image information regarding the road surface obtained by the first image sensor, the processor being configured to derive a direction information regarding a direction of the vehicle based on the first information.

2. The positioning system according to claim 1, wherein
the processor is configured to derive a movement amount information regarding the movement amount of the vehicle based on the first information.

3. The positioning system according to claim 2, wherein
the processor is configured to derive a position information regarding the position of the vehicle based on the direction information and the movement amount information.

4. The positioning system according to claim 1, wherein
the processor is configured to derive a movement amount information regarding the movement amount of the vehicle based on the first information, and
the processor is configured to derive the direction information based on a first distance between a position of the first image sensor in the vehicle and a rotation center of the vehicle and at least a part of the moving amount.

5. The positioning system according to claim 1, wherein
the processor is configured to derive a movement amount information regarding the movement amount of the vehicle based on the first information,
the moving amount includes a first moving amount in a first direction and a second moving amount in a second direction,
a plane including the first direction and the second direction crosses a third direction from the road surface to the first image sensor,
the second direction is orthogonal to the first direction,
the direction information includes information regarding a first angle, and
the first angle (degree) is expressed by [{(Px1²+Py1²)1/2}/(2n×r1)]×360,
the Px1 is the first direction moving amount,
the Py1 is the second direction moving amount, and
the r1 is a first distance between the position of the first image sensor in the vehicle and a rotation center of the vehicle.

6. The positioning system according to claim 1, wherein
the vehicle includes a base section away from the road surface,
the base section includes a base face facing the road surface, and
the first image sensor is provided on the base face.

7. The positioning system according to claim 1, wherein
the sensor section further includes a second image sensor,
the second image sensor is configured to image the road surface, and
the first information includes second image information regarding the road surface obtained by the second image sensor.

8. The positioning system according to claim 7, wherein
the processor is configured to distinguish a rotation of the vehicle and a translation of the vehicle based on the first image information and the second image information.

9. The positioning system according to claim 7, wherein
the moving direction of the vehicle includes a first component along a first direction and a second component along a second direction,
a plane including the first direction and the second direction crosses a third direction from the road surface to the first image sensor,
the second direction is orthogonal to the first direction,
a position of a rotation center of the vehicle in the first direction is between a position of the first image sensor in the first direction and a position of the second image sensor in the first direction, and
a position of the rotation center in the second direction is between a position of the first image sensor in the second direction and a position of the second image sensor in the second direction.

10. The positioning system according to claim 7, wherein
in a plane perpendicular to a direction from the road surface to the first image sensor, a rotation center of the vehicle is between at least a part of the first image sensor and at least a part of the second image sensor.

11. The positioning system according to claim 10, wherein
a first distance between the rotation center and the first image sensor is different from a second distance between the rotation center and the second image sensor.

12. The positioning system according to claim 1, wherein,
the first information does not include information from an inertial sensor.

13. A positioning method, comprising:
deriving a direction information regarding a direction of a vehicle based on a first information including a first image information regarding a road surface on which the vehicle travels,
the first image information being obtained by a first image sensor included in a sensor section provided in the vehicle.

14. The positioning method according to claim 13, further comprising:
deriving a moving amount information regarding a moving amount of the vehicle based on the first information.

15. The positioning method according to claim 14, further comprising:
deriving a position information regarding a position of the vehicle based on the direction information and the movement amount information.

16. The positioning method according to claim 13, further comprising:
deriving a movement amount information regarding the movement amount of the vehicle; and
deriving the direction information based on at least a part of the moving amount and a first distance between a position of the first image sensor in the vehicle and a rotation center of the vehicle.

17. The positioning method according to claim 13, wherein
the sensor section further includes a second image sensor,
the second image sensor is configured to image the road surface, and
the first information includes second image information regarding the road surface obtained by the second image sensor.

18. A vehicle, comprising:
a base section; and
a sensor section including a first image sensor and a second image sensor,
the base section being away from a road surface, the vehicle being configured to travel on the road surface,
a moving direction of the vehicle including a first component along a first direction and a second component along a second direction,
a plane including the first direction and the second direction crossing a third direction from the road surface to the first image sensor,
the second direction being orthogonal to the first direction, and
a position of the rotation center of the vehicle in the first direction being between a position of the first image sensor in the first direction and a position of the second image sensor in the first direction.

19. The vehicle according to claim 18, wherein
a position of the rotation center in the second direction is between a position of the first image sensor in the second direction and a position of the second image sensor in the second direction.

20. The vehicle according to claim 18, further comprising:
a processor,
the processor being configured to process a first information including a first image information regarding the road surface obtained by the first image sensor and a second image information regarding the road surface obtained by the second image sensor, and to derive a direction information regarding a direction of the vehicle based on the first information.
